(19) United States
(12) Patent Application Publication
(10) Pub. No.: US 2009/0066124 A1
(43) Pub. Date: Mar. 12, 2009

(54) SEAT SUPPORTING ASSEMBLY OF BICYCLE

(76) Inventor: Fabrizio Pirovano, Taichung City (TW)

Correspondence Address: Chien-Hui Su, P. O. Box 70-121 Taichung, Taichung City, 40899, TW

(21) Appl. No.: 11/853,028

(22) Filed: Sep. 11, 2007

(51) Int. Cl. B62J 1/00

(52) U.S. Cl. 297/195.1

(57) ABSTRACT

A seat supporting assembly of a bicycle, comprises a seat tube having a shape as a wing of a plane; a seat rod received in a hollow shape of the seat tube; the seat rod having a shape as a plane wing corresponding to that of the seat tube; the seat rod having a first inclined surface and a through hole; a tightening assembly having a tightening unit and a stud; the tightening unit having a second inclined surface, an outer periphery and a stud hole; the second inclined surface having a shape corresponding to that of the first inclined surface; the outer periphery of the tightening unit being matched to an inner wall of the hollow space of the seat rod; the stud hole is corresponding to the through hole of the seat rod. The seat tube has the effect of reduction of the rotation of the seat rod.

### FIELD OF THE INVENTION

The present invention relates to a seat supporting assembly of a bicycle, wherein the seat tube thereof has a non-round shape so as to make the seat rod being tightly engaged to the seat tube without rotation. Moreover, the elevation of seat rod is adjustable.

### BACKGROUND OF THE INVENTION

In the prior art bicycle, the seat tube has a round shape. A seat rod is engaged to the seat tube. In using, the height of the seat rod is adjustable with respect to the seat tube so as to have a desired height, which is suitable to the height of the driver. Because the seat tube has a round shape and the seat rod also has a round shape, the seat rod will rotate with respect to the seat tube.

However the poses and shapes of the drivers are different from one to one and thus the prior art structure has some difficult problems in use.

Moreover, in the prior art structure, the orientation of the seat is not suitable to be adjusted so that the user can not have a preferred cushion position.

Therefore, there is an eager demand for a novel design which can improve the prior art defects.

### SUMMARY OF THE INVENTION

Accordingly, the primary object of the present invention is to provide a seat supporting assembly of a bicycle, wherein the seat tube thereof has a non-round shape so as to make the seat rod is tightly engaged to the seat tube without rotation. Moreover, the elevation of seat rod is adjustable.

To achieve above objects, the present invention provides a seat supporting assembly of a bicycle which comprises a seat tube having a shape as a wing of a plane; a seat rod received in a hollow shape of the seat tube; the seat rod having a shape as a wing of a plane corresponding to that of the seat tube; the seat rod having a first inclined surface and a through hole; a tightening assembly having a tightening unit and a stud; the tightening unit having a second inclined surface, an outer periphery and a stud hole; the second inclined surface having a shape corresponding to that of the first inclined surface; the outer periphery of the tightening unit being matched to an inner wall of the hollow space of the seat rod; the stud hole is corresponding to the through hole of the seat rod. The seat tube has the effect of reduction of the rotation of the seat rod; the outer periphery of the tightening unit causes that the tightening unit is adhered to an inner surface of the hollow shape of the seat rod. When screwing the stud, the tightening unit will slide along the first inclined surface so that the tightening unit will tightly resists against the seat rod.

The various objects and advantages of the present invention will be more readily understood from the following detailed description when read in conjunction with the appended drawing.

### BRIEF DESCRIPTION OF THE DRAWINGS

FIG. 1 is an explosive schematic view about the seat supporting assembly of a bicycle of the present invention.

FIG. 2 is a front plane view of the seat supporting assembly of a bicycle of the present invention.

FIG. 3 is a schematic view about the seat supporting assembly of a bicycle of the present invention.

FIG. 4A is a schematic sectional view showing the releasing state of the present invention.

FIG. 4B is a schematic view showing the tightening state of the present invention.

FIG. 4C is a schematic view showing the operation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

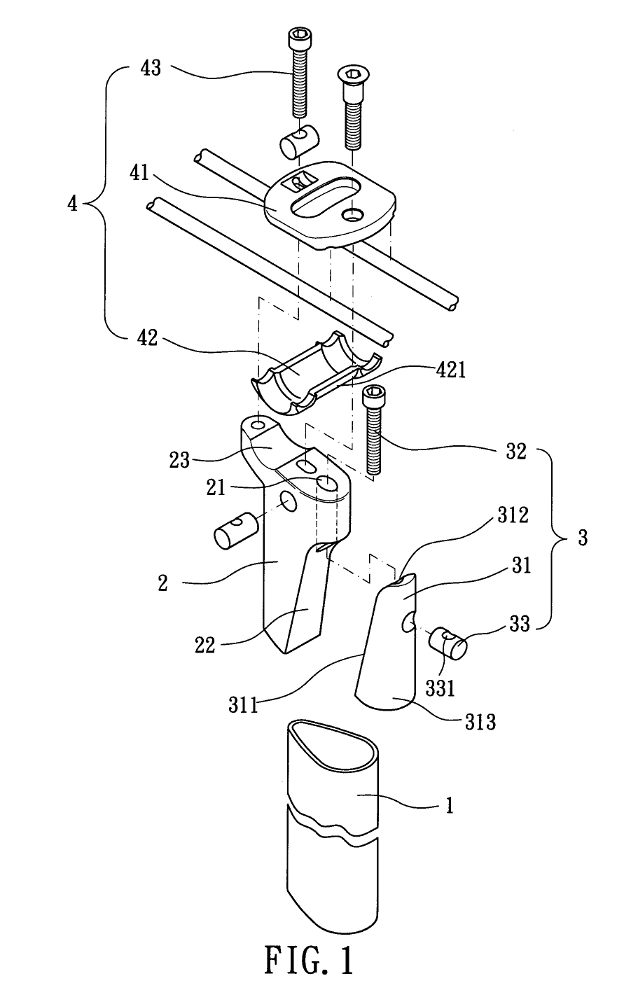

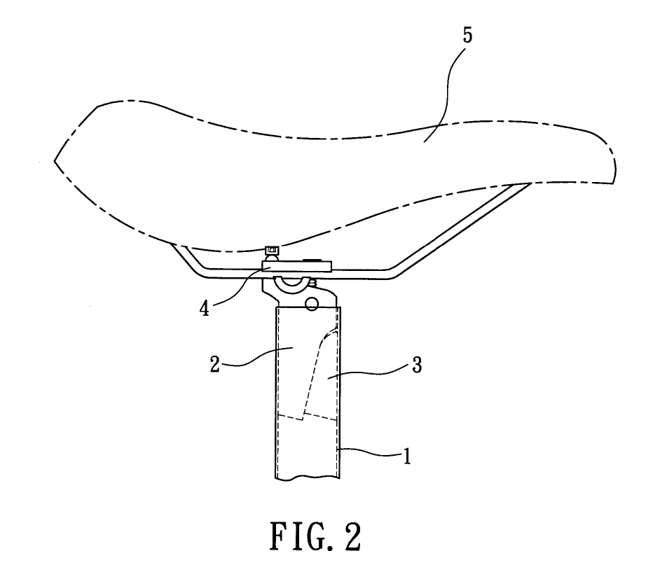

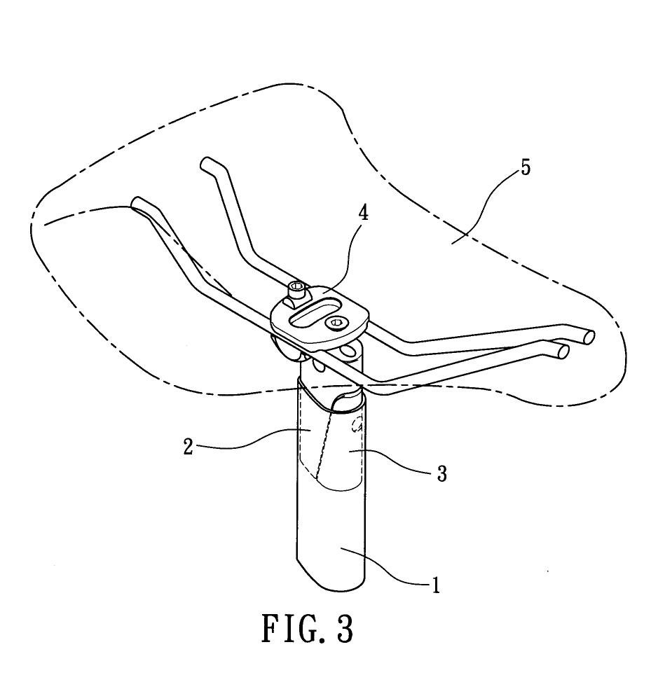

Referring to FIGS. 1 to 3, the structure of the present invention is illustrated. The present invention has the following elements.

A non-round seat tube 1 has a shape like a wing of a plane which can reduce the resistance force of wind.

A seat rod 2 can be embedded into a hollow space of the seat tube 1. A rear lateral side of the seat rod 2 is formed as a first inclined surface 22. A through hole 21 penetrates from an upper surface of the seat rod 2 to the first inclined surface 22. The seat rod 2 may be made of aluminum alloy or carbon fiber. The non-round structure of the seat tube 1 and the seat rod 2 will make the seat rod 2 not rotate in the seat tube 1.

A tightening assembly 3 is a tightening unit 31, a stud 32 and an engaging end 33.

The tightening unit 31 has a second inclined surface 311, an outer periphery 313, and a stud hole 312. The second inclined surface 311 is corresponding to the first inclined surface 22. The outer periphery 313 of the tightening assembly 3 is matched to an inner wall of the hollow space of the seat tube 1. The position of the stud hole 312 is corresponding to that of the through hole 21 of the seat rod 2. The tightening assembly 3 may be made by metal, such as iron alloy, aluminum alloy, or non-material material, such as rubber or plastics. All these are within the scope of the present invention. The outer periphery 313 can be a coarse surface by sanding, forming particles or patterns, etc. so as to have preferred friction forces.

The embedding unit 33 has a thread hole 331 having threads therein. The embedding unit 33 is embedded into a hole of the tightening unit 31. It will induce that the embedding unit 33 is enclosed in the tightening unit 31 as in plastic forming.

In assembly of the present invention, the stud 32 passes through the through hole 21 of the seat rod 2, the stud hole 312 and then to the thread hole 331 of the embedding unit 33. In screwing, the seat rod 2 and the tightening assembly 3 are engaged to the seat tube 1. Then the height is adjusted as desire of the driver. The outer periphery 313 is adhered to an inner surface of the seat tube 1. In operation, the stud 32 is screwed into the seat tube 1 and the tightening assembly 3, wherein the tightening unit 31 slides along the first inclined surface 22 until the tightening unit 31 sufficiently resists against the first inclined surface 22 and the inner wall of the seat tube 1. Thereby the seat tube 1 is locked with the seat rod 2.

In the present invention, an upper surface of the seat rod 2 is formed with a concave portion 23 which has a cambered shape.

The present invention further includes an adjusting unit 4 for adjusting the position and orientation of a cushion 5. The adjusting unit 4 includes an upper retaining unit 41, a lower adjusting unit 42 and a plurality of screw units 43. The upper retaining unit 41 and the lower adjusting unit 42 serve to tightly engage the cushion 5. The lower adjusting unit 42 is formed with a convex portion 421 which resists against the concave portion 23 of the seat rod 2. The inclination of the adjusting unit 4 is adjustable according to the requirement of the driver. The screw units 43 serve to lock the upper retaining unit 41, lower adjusting unit 42 and the seat rod 2 so as to firm secure the cushion 5.

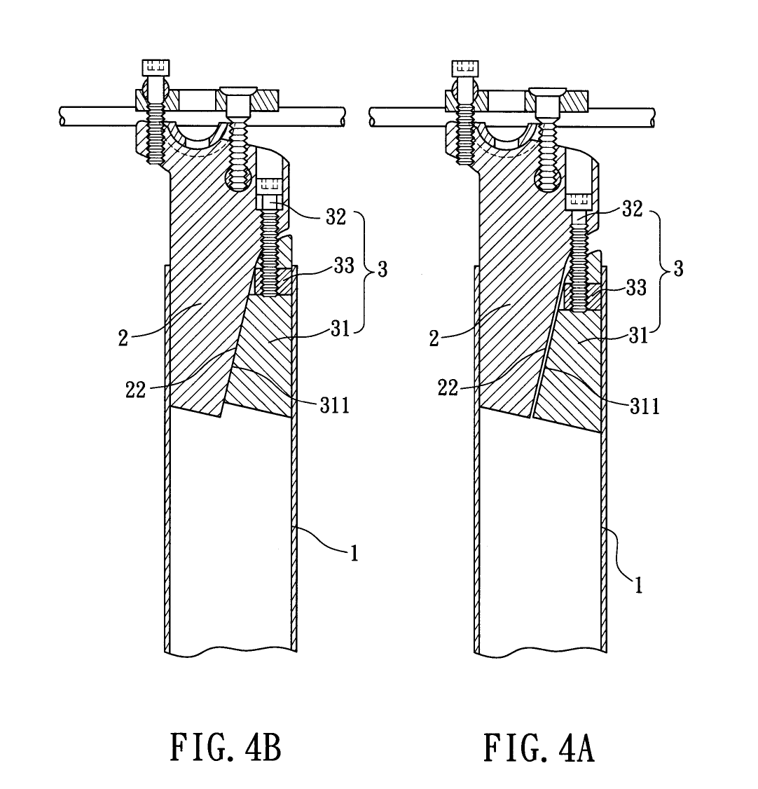

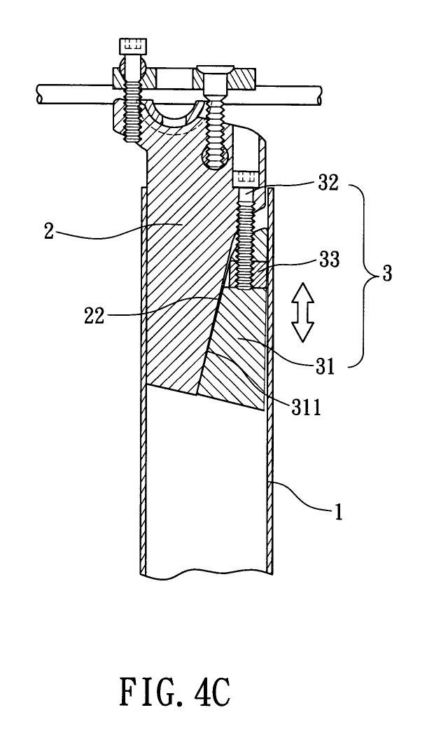

Referring to FIGS. 4A to 4C, the operation of the present invention is illustrated. In FIG. 4a, it is illustrated that the seat rod 2 and the tightening assembly 3 are engaged to the seat tube 1. The outer periphery 313 is adhered to an inner surface of the seat tube 1. The first inclined surface 22 and second inclined surface 311 has a gap therebetween. In FIG. 4C, it is illustrated that the stud 32 is screwed into the embedding unit 33. To drive the tightening unit 31 to move upwards, the first inclined surface 22 will contact the second inclined surface 311. In FIG. 4B, it is illustrated that the tightening unit 31 resists against the inner surface of the first inclined surface 22 and the seat tube 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A seat supporting assembly of a bicycle, comprising:
a seat rod having a non-round shape; the seat rod having a first inclined surface;
a tightening assembly having a tightening unit; the tightening unit having a second inclined surface corresponding to the seat rod;
wherein the non-round seat rod has the effect of reducing rotation; and the tightening unit is slideable along the first inclined surface so that the tightening unit can be locked.

2. The seat supporting assembly of a bicycle as claimed in claim 1, further comprising: an adjusting unit; wherein an upper surface of the seat rod has a concave portion and a lower side of the adjusting unit has a convex portion by the engagement of the concave portion and the convex portion, the inclination of the adjusting unit is adjustable.

3. The seat supporting assembly of a bicycle as claimed in claim 1, wherein the tightening unit is made of plastic or rubber.

4. The seat supporting assembly of a bicycle as claimed in claim 1, wherein a surface of the tightening unit is a coarse surface by using sanding, forming particles or patterns.

5. The seat supporting assembly of a bicycle as claimed in claim 1, wherein the seat rod has a shape like a wing of a plane.

6. The seat supporting assembly of a bicycle as claimed in claim 1, wherein the tightening unit has a stud and an embedding unit; the embedding unit is embedded into the tightening unit; and the stud serves to lock the seat rod and the tightening unit so that the tightening unit slides along the first inclined surface of the seat rod to a position for locking the seat rod to the tightening unit.

7. A seat supporting assembly of a bicycle, comprising:
a seat tube having a shape as a wing of a plane.
a seat rod received in a hollow shape of the seat tube; the seat rod having a shape as a wing of a plane corresponding to that of the seat tube; the seat rod having a first inclined surface and a through hole;
a tightening assembly having a tightening unit and a stud; the tightening unit having a second inclined surface, an outer periphery and a stud hole; the second inclined surface having a shape corresponding to that of the first inclined surface; the outer periphery of the tightening unit being matched to an inner wall of the hollow space of the seat rod; the stud hole is corresponding to the through hole of the seat rod;
wherein the seat tube has the effect of reduction of the rotation of the seat rod; the outer periphery of the tightening unit causes that the tightening unit is adhered to an inner surface of the hollow shape of the seat rod; when screwing the stud, the tightening unit will slide along the first inclined surface so that the tightening unit will tightly resists against the seat rod.

8. The seat supporting assembly of a bicycle as claimed in claim 1, further comprising: an adjusting unit; wherein an upper surface of the seat rod has a concave portion and a lower side of the adjusting unit has a convex portion by the engagement of the concave portion and the convex portion, the inclination of the adjusting unit is adjustable.

9. The seat supporting assembly of a bicycle as claimed in claim 7, wherein a surface of the tightening unit is a coarse surface by using sanding, forming particles or patterns.

10. The seat supporting assembly of a bicycle as claimed in claim 7, wherein the tightening unit is made of plastic or rubber.
